(19) United States
(12) Patent Application Publication
(10) Pub. No.: US 2014/0278548 A1
(43) Pub. Date: Sep. 18, 2014

(54) SYSTEM AND METHOD FOR PROVIDING ELECTRONIC ACCESS TO PATIENT-RELATED SURGICAL INFORMATION

(71) Applicant: EASE Applications, LLC, Orlando, FL (US)

(72) Inventors: Hamish M. MUNRO, Orlando, FL (US); Kevin J. de la ROZA, Orlando, FL (US)

(73) Assignee: EASE APPLICATIONS, LLC, Orlando, FL (US)

(21) Appl. No.: 14/207,773

(22) Filed: Mar. 13, 2014

Related U.S. Application Data
(60) Provisional application No. 61/789,555, filed on Mar. 15, 2013.

(51) Int. Cl. G06F 19/00; H04W 4/12

(52) U.S. Cl. CPC G06F 19/3418; G06F 19/322; H04W 4/12
USPC 705/3

(57) ABSTRACT

A system and method for providing electronic access to medical events via a secure mobile to mobile communication network. The system and method includes recording on a first mobile device a photographic, video, audio, or textual format patient relating data during a medical procedure. The recorded data is transmitted to a second mobile device operable for receiving communications via a secure link in the recorded formats. All data is transmitted via a secure encrypted means. Alternatively, the first and second mobile devices may be enabled with software operable for receiving, storing and transmitting data. The first mobile device recording data and storing same in a database or memory resident on the mobile device or housed within a communication server communicably linked to the first mobile device. Thereafter, the data may be unidirectionally transmitted in an encrypted manner to the second mobile device and subsequently viewed by a user.

### RELATED APPLICATIONS

This application claims priority to and is a non-provisional of U.S. Provisional Patent Application No. 61/789,555 filed Mar. 15, 2013, entitled “System and Method for Providing Electronic Access to Patient-Related Surgical Information,” the contents of which is incorporated by reference.

### FIELD OF THE INVENTION

The present disclosure relates generally to systems and methods of using computing and communication devices in a hospital environment, and more particularly, to systems and methods of providing third parties with mobile access to electronic patient-related data such as electronic status updates and explanations in the form of texts, videos, and pictures of a patient undergoing a medical or surgical procedure.

### BACKGROUND OF INVENTION

Surgical procedures are a huge event in a person's life and typically family members of hospitalized patients are usually concerned about the health and well-being of their loved ones. Immediate family members, relatives and close friends for a hospitalized patient undergoing surgery often gather for hours or even days in hospital waiting rooms, lobbies, and cafeterias while awaiting information on the status of their hospitalized relative.

In a surgical setting, relatives of patients often receive information that is frequently insufficient, incomplete, and less than timely. For a good portion of the time, relatives do not have access to information they would like to have. In particular, parents of pediatric patients are increasingly demanding more information regarding the events which occur during a surgery. This increase in demand is believed to be the product of an increase in anxiety for the relatives. While the topic of pre-operative anxiety in children awaiting surgery has been extensively published in medical literature, little attention has been paid to the anxiety faced by parents and other family members while waiting for their child's procedure to be completed. (This is also true when the patient is an adult) Indeed, many pediatric cardiac related procedures are both complex and lengthy. They are performed on a wide age range of patients, from newborn babies to older teenagers. The length of time for such procedures is very stressful for all the family members involved. A recent study compared the anxiety experienced by mothers of children undergoing surgery with female patients undergoing surgery themselves. This study found that the mothers were more anxious than the surgical patients themselves (Anesth Analg 2008; 106:810-813). Easing a patient's or a patient family's anxiety is also beneficial to the hospital as health care provider satisfaction scores are becoming more incorporated into the heath care model. Profitability and financial incentives are being tied to satisfaction scores and anything that can ease anxiety helps these numbers.

Today's healthcare model encourages a family-centered approach. Parents, immediate family members and relatives are increasingly being allowed to be present at the induction of and emergence from anesthesia, during dental procedures, on intensive care rounds and during invasive procedures and trauma resuscitation in the emergency room. A systematic review of the role of parental presence in the context of medical procedures showed there are potential advantages for parents. (Child Care Health Dev 2005; 31:233-43.) However, for obvious reasons, relatives are still not permitted to be present during the operative event itself. Thus, a need exists for a system and method of communication with family members and relatives of patients undergoing a medical or surgical event during the event itself and still complying with privacy laws (such as HIPAA in the United States).

Presently, limited information is communicated to relatives via person-to-person verbal communications which sometimes are difficult to comprehend in lay person's terms. Such information may be provided by a nurse practitioner to the relatives in periodic intervals. This information, however, is oftentimes presented in a disorganized manner as relatives have to wait to receive information verbally from nurses or attending physicians on a catch-as-catch-can basis. Attempts have been made to provide relatives and patients with information during a surgical event. Such attempts include having a nurse practitioner generate and send a predefined or generic text message or email to the relatives of a patient at a predetermined time interval. For example, once the patient is asleep, a text message may be sent to the relatives which states: “Patient is asleep.” While this information is helpful, it does not provide the relatives with detailed information to assess and understand the progress of the surgical procedure. Also, such predefined messages may feel impersonal and only slightly ease the anxiety present. In addition the use and incorporate of photos and video add an additional level of detail not currently available. Also of note, currently available systems utilize stationary devices which do not allow for the possibilities and flexibility allowed by mobile devices and mobile device applications.

Earlier attempts at addressing some of these problems have focused on other areas. Japanese Patent No. 2003162586 addresses only the patient side of treatment and fails to address the concerns and worries of the patient's family during operative procedures. In addition this patent deals with post-operative procedures and follow-up care. Also, the patent fails to disclose the use of mobile devices or for that matter compliance with U.S. based HIPAA regulations/procedures via the use of encryption or other means.

US Patent Application 2004/0073453 introduces the use of PDA's for the transmission of information regarding a patient (notably PDA's having only limited texting, photographic and/or recording ability). The invention discloses a use in a health care system where multiple persons inside the network can receive updates and information. Furthermore, the use of properly enabled devices is required, and the downloading of software onto a person's mobile device is not possible in this embodiment. In addition, the network of this embodiment is broad and includes others in the health care hierarchy, not just the operating room and a patient's family. Finally, the information transmitted is not surgery related, but a flow of information including status of a patient in a hospital room or even the results of a test performed (whereas the present invention focuses primarily on the medical procedures and pre- and post-operative care involved with same). Here again, HIPAA compliance may be at issue as the level of encryption used may expose private patient information. Also at issue is the need for specified hardware, whereas the present invention is accessible on nearly any mobile device or phone and in one embodiment is available via a mobile “app” store.

US Patent Application 2010/0250270 discloses a hospital scheduling system which aids the surgical flow and efficiency of same. The flow of information in this embodiment is between hospital personnel and not to a patient's family. This embodiment also seems to utilize canned or pre-arranged messages which do little to ease anxiety of a patient's family. The application also utilizes “foot-based” transmissions where hospital personnel sends message with foot operated devices.

Based on the foregoing, a need exists for providing detailed information to relatives of a patient undergoing a surgical procedure and for providing relatives of a patient information relating to a patient's condition during a surgical event in a more efficient and effective manner. Relatives should have the ability to find out the current status of the patient at any given time during a surgical procedure. Relatives should also be promptly informed about critical new information about the patient's status. Such information should be provided in various formats, thereby providing the relatives of a patient with more detail that is capable of decreasing the anxiety and stress related to the procedure. Post-discharge plans such as follow-up care and explanations of physicians' plans for further treatment and tests may also be included. In another embodiment pre-operative plans can be sent via the system, for example instructing a patient not to eat after midnight. Finally, customer satisfaction improves with the feedback provided by the users helping to improve overall hospital satisfaction scores which results in satisfied patients and improved profitability.

In addition, the communication of medical information such as patient updates should be transmitted via a secure system. Such a system would desirably be HIPAA compliant.

### SUMMARY OF INVENTION

In one embodiment the present invention discloses a method of supplying information concerning a patient undergoing a medical procedure, the method comprising recording on a first mobile device in any one of a photographic, video, audio, or textual format patient related data during a surgical procedure, storing the data in a memory of the first mobile device or a database housed within a server communicably linked to the first mobile device, transmitting the data to one or more recipient devices operable for receiving communications via a secure link in any one of the recorded formats, and deleting the transmitted data from the one or more recipient devices at a timed interval after the transmission.

In another embodiment, the present invention discloses a system for supplying information concerning a patient undergoing a medical procedure, the system comprising a first mobile device able to record in any one of a photographic, video, audio, or textual format patient related data during a surgical procedure, the first mobile device able to store the data in memory or the first mobile device communicably linked to a server and database, the first mobile device capable of transmitting the data to one or more recipient devices operable for receiving communications via a secure link in any one of the recorded formats, and the one or more recipient devices deleting the transmitted data at a timed interval after the transmission.

To achieve the foregoing and other objects, and in accordance with the purposes of the disclosure as embodied and broadly described herein, the present disclosure provides various embodiments of system and method of communicating patient related data to relatives of the patient during a surgical event. Such a system generally includes a first and a second mobile communication device such as a smartphone and a network or cellular server. The first and second mobile communication devices are configured to transmit and receive text messages, electronic mail, photographs and video. In various embodiments, the method generally includes the steps of:

1. Providing a healthcare provider with an enabled device, or alternatively the provider using their own device with enabled software, (such a device would have a software application resident in its memory, the software application being operable for recording patient data, storing patient data in a secure database, transmitting the patient data to a network server) and in one embodiment providing training and software to the healthcare provider;

2. Identifying potential primary recipient participants for receiving patient related data;

3. Having a representative of the healthcare provider explain the procedure for communication, that it is a one way format with periodic data transmission occurring;

4. Having the primary recipient participants download and install a secure software application onto their personal mobile communication device or receiving a previously enabled device from the healthcare provider;

5. Having the primary recipient participants and the patient, if of age, agree to terms and conditions of use via a consent/disclaimer document;

6. Having the primary recipient participant elect the format of communication, e.g., text only or any one of text, audio, photograph or video;

7. Having the primary recipient participant elect secondary participants and enabling the secondary participants mobile devices;

8. Optionally establishing a link between the primary recipient participant and the secondary participants mobile devices and a secure network server which is operable for receiving, transmitting and storing patient related data;

9. Initiating the software application and having the healthcare provider generate and transmit a test message in the elected format to both the primary and secondary participants;

10. Having a healthcare representative, such as a nurse practitioner, present during the surgical procedure record and/or generate a status update data regarding the procedure, including but not limited to, recording video or photographic images, generating text or email messages, or generating voice messages;

11. Having the healthcare representative transmit the status update data to either a secure network server or directly to the primary recipient participant;

12. Having the software application delete the transmitted status update data at a timed interval after transmission from all mobile devices;

13. Transmitting an end of procedure survey to all participants; and

14. Deleting and purging all patient related data subsequent to the surgical procedure from all mobile devices, but alternatively retaining the data in an area similar, but not limited to secure cloud storage.

In one embodiment, the present invention uses personal cellular phones, enabled with the appropriate software, to transmit unidirectional texts, images, and videos with the permission provided by the signed surgical consent to the parents of children (or families of patients) undergoing medical procedures such as, but not limited to, diagnostic and interventional cardiac catheterizations and cardiac surgical procedures, both on and off cardiopulmonary bypass (or any other major surgical procedure). Parents and families are offered this service during the preoperative visit and are asked if they would like to receive either pictures, videos and texts, or just texts alone. A member of the operating room staff then records and transmits images and texts as soon as the patient safely falls asleep, and at various times during the procedure, ensuring that vigilance and patient safety remain paramount. The images include intra-operative photos or short video clips of anatomy and surgical repairs as well as angiograms and x-rays from the cath lab (and any additional information that explains the medical process). Following the procedure, the parents may be asked to complete a short questionnaire in an effort improve the process and seek their comments and suggestions. The results of this questionnaire then being made available to the healthcare provider in order to help to improve processes and thereby improving patient and family satisfaction.

Additional features and advantages of the invention are set forth in the detailed description which follows and will be readily apparent to those skilled in the art from that description, or will be readily recognized by practicing the disclosure as described in the detailed description, including the claims, and the appended drawings. It is also to be understood that both the foregoing general description and the following detailed description present exemplary embodiments of the disclosure, and are intended to provide an overview or framework for understanding the nature and character of the disclosure as it is claimed. The accompanying drawings are included to provide a further understanding of the disclosure, and are incorporated into and constitute a part of this specification. The drawings illustrate various embodiments of the disclosure, and together with the detailed description, serve to explain the principles and operations thereof. Additionally, the drawings and descriptions are meant to be merely illustrative and not limiting the intended scope of the claims in any manner.

### BRIEF DESCRIPTION OF THE DRAWINGS

The foregoing and other objects, aspects, and advantages will be better understood from the following description of exemplary embodiments of the disclosure with reference to the drawings, in which:

FIG. 1 is flow diagram of a method of providing electronic access to patient related data during a surgical procedure in accordance with an exemplary embodiment of the present disclosure and illustrating certain components thereof;

FIG. 2 is a pictorial diagram of four sample images transmitted during a surgical procedure in accordance with an exemplary embodiment of the present disclosure;

FIG. 3 is a pictorial diagram of sample images stored and generated into a PowerPoint, booklet, or short book of a surgical procedure in accordance with an exemplary embodiment of the present disclosure;

FIG. 4 is a pictorial representation of the flow of information transmitted during a surgical procedure in accordance with an exemplary embodiment of the present disclosure;

FIG. 5 is a pictorial diagram of the secure login procedure for electronic access to patent data during a surgical procedure in accordance with an exemplary embodiment of the present disclosure;

FIG. 6 is a pictorial diagram of the reminder sent to the health care team during a surgical procedure in accordance with an exemplary embodiment of the present disclosure; and

FIG. 7 is a pictorial diagram of a request for the user to acknowledge the type of data transmission during a surgical procedure in accordance with an exemplary embodiment of the present disclosure.

### DETAILED DESCRIPTION OF THE INVENTION

Reference will now be made in detail to exemplary embodiments of the disclosure, which are illustrated in the accompanying drawings. Whenever possible, the same reference numerals will be used throughout the drawings to refer to the same or like parts. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

In one embodiment the present invention discloses a method of supplying information concerning a patient undergoing a medical procedure, the method comprising recording on a first mobile device in any one of a photographic, video, audio, or textual format patient related data during a surgical procedure, storing the data in a memory of the first mobile device or a database housed within a server communicably linked to the first mobile device, transmitting the data to one or more recipient devices operable for receiving communications via a secure link in any one of the recorded formats, and deleting the transmitted data from the one or more recipient devices at a timed interval after the transmission.

In another embodiment, the present invention discloses a system for supplying information concerning a patient undergoing a medical procedure, the system comprising a first mobile device able to record in any one of a photographic, video, audio, or textual format patient related data during a surgical procedure, the first mobile device able to store the data in memory or the first mobile device communicably linked to a server and database, the first mobile device capable of transmitting the data to one or more recipient devices operable for receiving communications via a secure link in any one of the recorded formats, and the one or more recipient devices deleting the transmitted data at a timed interval after the transmission.

The present disclosure, in still another embodiment, provides a system and method for providing electronic access to surgical events or procedure via a mobile to mobile communication network. More specifically, surgical/medical events data relative to a patient's status during a surgery may be recorded on a first mobile device in any one of a photographic, video, audio, or contextual format. Thereafter, the recorded surgical event data may be transmitted to a second mobile device operable for receiving communications other than voice calls via electronic mail, SMS messaging photo sharing, or the like. In other exemplary embodiments, each of the first and second mobile devices may install a software component operable for receiving, storing and transmitting secure data. The first mobile device may record the surgical event data and store the same in a database or memory resident on the mobile device or housed within a communication server that is communicably linked to the mobile device. In alternative embodiments, the first mobile device may record the surgical event data and store the same for a specific period of time before being purged in a database or memory resident on the mobile device or housed within a communication server that is communicably linked to the mobile device. Thereafter, the event data may be transmitted in an encrypted manner to the second mobile device and subsequently viewed by a user.

FIG. 1 provides a flow diagram of a method 10 of providing electronic access to patient related data during a surgical procedure in accordance with an exemplary embodiment of the present disclosure and illustrating certain components thereof is illustrated. The steps are for demonstrative purposes and steps may be combined or omitted in various embodiments of the present invention. As shown, at step 12, a healthcare provider is first provided with an enabled mobile device, or the healthcare provider installs the application on their own personal device, (such a device having a software application resident in its memory, the software application being operable for recording patient data, storing patient data in a secure database or memory, or transmitting the patient data to a network server for storage or transmission to a secondary mobile device). Alternatively, the healthcare provider may utilize a mobile device connected, via wireless or cellular, to a stationary device, such as a computer connected to a network, in order to facilitate transmission. In one embodiment the data transmission utilizing at least 256-bit encryption.

In step 14, potential primary recipient participants for receiving patient related data are identified. In one embodiment, parents or relatives of pre-operative patients are asked if they wish to receive periodic, near real-time status updates of the patient's condition during a the surgical procedure and if they wish to participate in the presently disclosed method. In step 16, a representative of the healthcare provider explains the procedure for communication, e.g., having a healthcare representative, such as a nurse practitioner, generate and send out unidirectional data relating to the patient's condition and the surgical procedure itself.

In step 18, after having the communication procedure explained in step 16, and if the parents or relatives elect to become a primary recipient participant, then a software application is downloaded and installed on an enabled personal mobile device belonging to the parents or relatives. In one embodiment the health care provider providing devices for temporary use by friends/family. It will be understood by those skilled in the art, that any smartphone or communication device capable of downloading, installing and running the software application will be suitable. Such communication devices being configured to send, receive and display audio, textual, photographic, and video messages.

In step 20, the primary recipient participants and the patient, if of age, will also agree to terms and conditions of use and execute a predefined document setting forth the limited mode of communication and predefined disclaimers. It will be understood by those skilled in the art that the disclaimers may also include appropriate waivers of liability. In step 21 the primary recipient provides information such as, but not limited to, patient's first and last name, the patient's date of birth, date of the procedure, and the primary recipients email address to create an account for that procedure. In one embodiment, a code corresponding to this account is generated which is then scanned by the healthcare provider to create the secure communications link. (See FIG. 5)

In step 22, the primary recipient participant is presented with and elects one of various formats for the communications, e.g., text only or any one of text, audio, photograph or video (see also FIG. 7.) In step 24, the primary recipient participant may also elect secondary recipient participants to receive these communications. (FIG. 4 pictorially representing the secondary recipients receiving said communications.) In exemplary embodiments, the secondary participants will also execute the disclaimer document and download the software application to their personal mobile communication devices. In one embodiment, steps 21, 22 and 24 all being interchangeable. Notably the secure sending and receipt of information complying with privacy laws (such as HIPAA in the United States).

In step 24, a link between the healthcare provider's enabled communication device, the primary recipient participant and the secondary participants mobile devices, 26 and 28, respectively, and a secure network server which is operable for receiving, transmitting and storing patient related data is established. In one embodiment the link being accessed via the secure login as seen in FIG. 5. In another embodiment the secure link and communications utilizing cloud based storage systems.

In step 30, the software application is opened or accessed by the primary and secondary participants and the healthcare provider generates and transmits a test message in the elected format to both the primary and secondary participants. In exemplary embodiments, the test message may be a predefined message stored on a server (or free text entry) and sent automatically upon initial access to the software application.

In step 32, once the surgical procedure begins, a healthcare provider representative, such as a nurse practitioner or other clinical staff member, present during the surgical procedure may periodically record and/or generate status update data regarding the procedure and the patient's condition. The update data may be recorded in the elected format of the primary participant, including but not limited to, video or photographic images, text, or audio formats. Preferably the update being case or patient specific and not a series of pre-determined messages. Once the update data is recorded or generated, the healthcare provider representative may transmit the status update data to either a secure network server or directly to the primary recipient participant. In exemplary embodiments, if the transmission is direct to the primary and secondary participants, then the communication is unidirectional only. In one embodiment the health-care provider periodically being reminded to send an update via a message as seen in FIG. 6. All communications are temporary in nature and disappear after a set time frame. In one embodiment, the communication disappears (or is deleted) from the recipients mobile device after 45 seconds.

FIG. 2 provides a pictorial diagram of four sample images transmitted during a surgical procedure in accordance with an exemplary embodiment of the present disclosure is illustrated. As shown, the transmitted images 100 may include textual messages 120, photographs 110, videos (not shown) or any combination thereof. In another embodiment this may also include audio. In some embodiments, the participants may respond or reply, at select times, to the transmitted messages 130. While FIG. 2 provides an example of use on a smart phone or i-phones, the system is not limited to this embodiment and can be installed on any mobile device. FIG. 2 details a standard text messaging environment, however additional embodiments for the messaging environment are possible and are not limited to standard messaging appearances or environments. In another embodiment, the system can be installed on a stationary device such as a laptop, tablet or home computer connected wirelessly to a network (or alternatively hardwired or connected via Ethernet). Such a setup would enable secondary recipients the ability to monitor from a home or office.

Referring back to FIG. 1, in step 32, all communications transmitted to the primary and secondary recipients are deleted at a predetermined time interval after transmission by a deletion feature resident within the software application. One embodiment utilizes 45 seconds, however any appropriate time limitation can be employed. Deletion of information primarily occurring on the mobile device, while retention on systems such as secure cloud storage are retained.

In step 34, an optional end of procedure survey is transmitted for completion to all participants. It will be appreciated by those skilled in the art that this end of procedure survey may be transmitted as a bidirectional communication, meaning that the participants may provide instant feedback. Alternatively, the end of procedure survey may be transmitted in the form of a request which includes a hyperlink to an out of application address for completion. The out of application address may be the healthcare provider's website or another Internet site conjured to prompt a series of questions and store responses for later access and use. This satisfaction survey allowing the heath care provider the ability to gauge strengths and weaknesses of the present invention and using the data obtained to enhance patient/family service and comfort.

In step 36, the software application ends and closes. The participants continued access is denied unless further authorized by the healthcare provider. In one embodiment, in step 38, the participants are asked if they wish to have any of the stored information reproduced in a book or DVD type format. In FIG. 3, a pictorial diagram of sample images 200 stored and generated into a PowerPoint, booklet, or short book of a surgical procedure in accordance with an exemplary embodiment of the present disclosure are illustrated. As shown, the sample images are configured to tell a story of the surgical procedure and may include any one of introductory information 210 relating to the hospital and doctors, introductory information relating to the patients pre-operative diagnosis and testing 240, images from the surgery 220, text messages transmitted during the surgery, 230 and a post procedure notes, images and instructions, if any 250. In one embodiment patient related data from the surgical procedure is maintained for an extended period of time, for example up to 8 years. In another embodiment patient or healthcare provider are able to access same via cloud or other based secure storage. In another embodiment, the data is stored in the health care provider's secure records and/or the patients electronic files.

Referring back to FIG. 1, in step 40, all update data recorded or stored is deleted from the healthcare provider's enabled mobile device and any recipients mobile device. Data recorded or stored can optionally be stored or retained on the server or cloud storage if desired.

In one embodiment, the primary recipient participant may also elect secondary recipient participants to receive these communications. FIG. 4 representing the network which can be created by this embodiment. Network 300 allows patient 310 (or patient's parents/guardians) to allow multiple recipients the ability to follow the procedure. Primary recipient 320 enacts the protocols previously defined to setup the method of providing information 315. (315 representing input by a medical team and then processing thru the system, the system being a mobile device, a CPU or any combination of same) In this embodiment, secondary participants 330 will also execute the disclaimer document and download the software application to their personal mobile communication devices. Secondary participants 330 can be, but are not limited to additional family, friends, offsite health care providers, students, professors, other doctors or any additional persons previously approved by patient 310. In this embodiment participants utilizing enabled mobile devices 340, however any device able to take a secured transmission can be used including wireless computers, hard wired computers, Ethernet connected computers or any device able to accept a secure transmission via a wireless or cellular network.

FIG. 5 provides background of one embodiment of the initial link 400 created between the healthcare provider's enabled communication device and the primary recipient participant and the secondary participants mobile devices. Here once the initial setup and installation of the system is performed, patient is provided a bar code or a QR code 410 or an access code 420 for login. This code permits access into the specific procedure being performed and adds a level of security to avoid improper transmission of the procedure.

FIG. 6 details one embodiment of the present invention where reminders are created for the health care provider. Here reminder application 500 creates a notification 510 to health care provider that a period of time has passed since the last update issued. Health care provider is reminded to type an update (or free text message) 520 to recipients. Typically this message is patient specific to help lessen the anxiety of recipient. In one embodiment an automatic reminder is programmed to be sent to ensure the recipients receive an update at a set interval, for example every 30 minutes.

FIG. 7 details another embodiment of the present invention where the recipient chooses the type of data to receive. In one embodiment data reception means 600 allows a user to receive text only 610, text and pictures 620 or text pictures and video 630. This setup can be configured as needed to allow a recipient to receive only the means of communication desired. In another embodiment audio may also be included. In yet another embodiment the user is able to switch between the data feeds they want to receive, for example if the photos sent make the user uncomfortable.

In another embodiment the health care provider can change or substitute the person sending the data. In one embodiment, an initial person sets up the data transmission via the secured means described above and then at a designated point, switches to a second (or third/fourth) person. Upon switching the system may optionally require a password and/or detailed login procedure.

In exemplary embodiments the software application and the methods of communication are secure and configured to be compliant with any government and/or institutional regulations imposed such as the US-Health Insurance Portability and Accountability Act (HIPAA) by maintaining the privacy and confidentiality of the patient. In one embodiment the data is transmitted via a secure means including the use of encryption and other means of data transmittal. Long term storage of data does not occur on the mobile devices employed and optionally is only stored on the medical providers secure system and/or cloud storage.

It will be apparent to those skilled in the art that various modifications and variations can be made to the present disclosure without departing from the spirit and scope of the disclosure. Thus, it is intended that the present disclosure cover all conceivable modifications and variations of this disclosure, provided those alternative embodiments come within the scope of the appended claims and their equivalents.

What is claimed is:

1. A method of supplying information concerning a patient undergoing a medical procedure, the method comprising:
recording on a first mobile device in any one of a photographic, video, audio, or textual format patient related data during a surgical procedure;
storing the data in a memory of the first mobile device or a database housed within a server communicably linked to the first mobile device;
transmitting the data to one or more recipient devices operable for receiving communications via a secure link in any one of the recorded formats; and
deleting the transmitted data from the one or more recipient devices at a timed interval after the transmission.

2. The method of claim 1 wherein the secure link requires the input of information by the first mobile device and the one or more recipient devices.

3. The method of claim 1 wherein the secure link and communications are encrypted.

4. The method of claim 1 wherein the secure link and communications utilize cloud based storage for the patient related data.

5. The method of claim 1 wherein the one or more recipient devices are mobile.

6. The method of claim 1 wherein the patient or parent/guardian of a minor patient undergoing a surgical procedure provides consent for the transmission of the patient related data.

7. The method of claim 1 wherein the patient related data from the surgical procedure is maintained for a period of time in a secure manner.

8. The method of claim 1 wherein the one or more recipient devices further request input on items related to the method of supplying information.

9. The method of claim 1 wherein the database housed within a server communicably linked to the first mobile device further comprises the use of an internet or wireless network.

10. The method of claim 1 wherein the one or more recipient devices request additional input regarding the transmission of photographic, video, audio, or textual data.

11. The method of claim 1 wherein the method further comprises a satisfaction survey.

12. A system for supplying information concerning a patient undergoing a medical procedure, the system comprising:
a first mobile device able to record in any one of a photographic, video, audio, or textual format patient related data during a surgical procedure;
the first mobile device able to store the data in memory or the first mobile device communicably linked to a server and database;
the first mobile device capable of transmitting the data to one or more recipient devices operable for receiving communications via a secure link in any one of the recorded formats; and
the one or more recipient devices deleting the transmitted data at a timed interval after the transmission.

13. The system of claim 12 wherein the secure link includes a required input of information by the first mobile device and the one or more recipient devices.

14. The system of claim 12 wherein the secure link and communications are encrypted.

15. The system of claim 12 wherein the secure link and communications utilize cloud based storage for the patient related data.

16. The system of claim 12 wherein the one or more recipient devices are mobile.

17. The system of claim 12 wherein the patient or parent/guardian of a minor patient undergoing a surgical procedure provides consent for the transmission of the patient related data.

18. The system of claim 12 wherein the patient related data from the surgical procedure is maintained for a period of time in a secure manner.

19. The system of claim 12 wherein the one or more recipient devices further request input on items related to the system of supplying information.

20. The system of claim 12 wherein the database housed within a server communicably linked to the first mobile device further comprises the use of an internet or wireless network.

21. The system of claim 12 wherein the one or more recipient devices request additional input regarding the transmission of photographic, video, audio, or textual data.

22. The system of claim 12 wherein the system further comprises a satisfaction survey.
